(19) United States
(12) Patent Application Publication
(10) Pub. No.: US 2005/0132332 A1
(43) Pub. Date: Jun. 16, 2005

(54) Multi-location coordinated test apparatus

(76) Inventor: Abhay Sathe, Fort Collins, CO (US)

Correspondence Address: AGILENT TECHNOLOGIES , INC.;Legal Department, DL429, Intellectual Property Administration, P.O. Box 7599, Loveland, CO, 80537-0599, US

(21) Appl. No.: 10/733,336

(22) Filed: Dec. 12, 2003

(51) Int. Cl. G06F 9/44

(52) U.S. Cl. 717/124

(57) ABSTRACT

An apparatus having: a library of software modules; and a graphical end user interface (GUI) via which an end user constructs a graphical model for a multi-location test of a network, the graphical model including flows respectively corresponding to test locations, a respective flow for a corresponding test location being a flow of software modules from the library.

### BACKGROUND OF THE INVENTION

1. Field of the Invention

The present invention relates to an apparatus for conducting multi-location coordinated tests, and more particularly, to an apparatus for conducting multi-location coordinated tests with reusable test modules

2. Description of the Related Art

The term ‘test software’ is used, to describe a software product whose primary function is to examine how a system is functioning. The test software collects its input from ‘probes’ placed in or near the system. Probes convert one or more attributes of the system into measurable numbers, and the test software converts this information into observable visual graphs, and/or audio or electronic alarms.

Some examples of implementations of test software are: river water quality monitors, automobile performance test systems, and telecommunications systems test systems.

Some systems under examination are geographically or temporally distributed. The test software for such systems needs to collect data from different locations or different times, to completely test the system. The test software also needs coordination and data exchange between different parts of the test software to carry out the examination in a meaningful manner.

One existing software application provides a tool called a ‘sequence test’ that allows creation of more complex test software using predefined software modules.

As shown in FIG. 1, for example, using a graphical interface, the test software end user creates a sequence of the software modules by ‘dragging’ existing modules into the ‘sequence test’. The ‘sequence test’ runs the modules on a regular periodic interval in the sequential order established by the end user (First test 30 through Last test 40). A data store 20 provides storage for test-generated data. Each time the sequence test is run, a module in the sequence can share data with the modules that run after it, by exporting the data to the data store 20.

This solution has several disadvantages. The sequence test is not multi-location; it only runs at one location. Additionally, the software modules used in the sequence, which run in a strictly sequential manner, do not have any co-ordination or message-passing capability between them, other than the data store 20, in which previously run software modules can leave data for the subsequent software modules to pick up.

Another existing software application provides the ability to create multi-location tests, but the end user must create the multi-location test by writing a customized software program for each location, to implement a sequence of actions. As shown in FIG. 2, for example, there is a custom test written for location A 50 and location B 60. This application provides tools for allocating the needed resources (test probes), and for starting multiple processes at different test locations. This application also allows coordination between the independently running processes on each location by sending co-ordination messages 70 and 80 from one location to another location that is waiting for a message.

This solution also has several disadvantages. There is no clear visual model to provide a link between the custom constructed code and the sequence of actions happening at each test location for the multi-location test. Additionally, the solution is not modular, and requires custom software creation for creating new multi-location tests. Further, the co-ordination messages do not have a well-defined structure. Such a well-defined structure is needed for creation of reusable software modules that can share test-generated data at test run time.

Thus, there are several problems with existing solutions. The existing solutions lack a clear and standardized visual model to construct complex multi-location tests, and thus, quickly creating a test model for a multi-location system under test is difficult. Additionally, there is no definition for the interface and behavior of software modules that can be integrated together, based on a visual model of a multi-location test. Further, there is no defined structure to exchange test-generated data between software modules during test operation.

### SUMMARY OF THE INVENTION

Accordingly, it is an aspect of the present invention to reduce the time required to create complex multi-location tests. It is another aspect of the present invention to reduce the cost of test construction by allowing less trained personnel to create complex multi-location tests, and re-use of well-tested software modules. It is yet another aspect of the present invention to reduce maintenance costs by promoting the use of standard test modules with well understood behavior, allowing support of tests constructed in the field without training support personnel on the specific test.

Additional aspects and advantages of the invention will be set forth in part in the description which follows, and in part, will be obvious from the description, or may be learned by practice of the invention.

The foregoing and/or other aspects of the present invention are achieved by providing an apparatus including: (a) a plurality of libraries of software modules maintained at a plurality of test locations, respectively, of a network; and (b) a graphical end user interface (GUI) via which an end user constructs a graphical model for a test of the network. The graphical model includes flows respectively corresponding to test locations. A respective flow for a corresponding test location is a flow of software modules from the library maintained at the corresponding test location.

The foregoing and/or other aspects of the present invention are also achieved by providing an apparatus including: (a) a library of software modules; and (b) a GUI via which an end user constructs a graphical model for a multi-location test of a network. The graphical model includes flows respectively corresponding to test locations. A respective flow for a corresponding test location is a flow of software modules from the library.

According to one aspect, the GUI is run at a location remote from at least one test location, so that the end user constructs the graphical model and runs the test from the remote location.

The foregoing and/or other aspects of the present invention are also achieved by providing an apparatus including: (a) a library of software modules, including test modules and coordination modules; and (b) a GUI via which an end user constructs a graphical model for a multi-location test of a network. The graphical model includes flows respectively corresponding to test locations. A respective flow for a corresponding test location is a flow of at least one software module. Test modules perform predefined test operations and coordination modules coordinate inter-operation of test modules in different flows.

The foregoing and/or other aspects of the present invention are also achieved by providing an apparatus including: (a) a library of software modules; and (b) a GUI via which an end user designs a graphical model of multi-location test software. In the graphical model, a flow of at least one software module is constructed for each test location.

The foregoing and/or other aspects of the present invention are also achieved by providing an apparatus including: (a) a library of software modules, including test modules, and coordination modules; (b) a GUI to design a graphical model of software to test multiple test locations of a network. In the graphical model, a flow of at least one software module is constructed for each test location. Coordination modules coordinate inter-operation of test modules in different flows and communicate test generated data with the different flows. The apparatus also includes (c) a conversion unit to generate the flows from the graphical model, and (d) at least one agent to run the flows. The apparatus further includes (e) at least one probe deployed at each test location to collect data from at least one attribute of the network and communicate the data with the at least one agent, and (f) a central controller to control running of the flows and collect the data from the at least one agent.

The foregoing and/or other aspects of the present invention are also achieved by providing a computer readable medium, including: (a) a first set of instructions housing a library of software modules, including test modules and coordination modules; (b) a second set of instructions creating a GUI via which via which an end user constructs a graphical model for a multi-location test of a network. The graphical model includes flows respectively corresponding to test locations, and a respective flow for a corresponding test location is a flow of at least one software module. The computer readable medium also includes: (c) a third set of instructions to convert the graphical model to a text representation of the multi-location test; (d) a fourth set of instructions controlling an agent to receive and analyze the text representation, access the library, and run the flows for each test location; and (e) a fifth set of instructions coordinating synchronization and exchange of test generated data between flows.

### BRIEF DESCRIPTION OF THE DRAWINGS

These and/or other aspects and advantages of the present invention will become apparent and more readily appreciated from the following description of the embodiments, taken in conjunction with the accompanying drawings, of which:

FIG. 1 illustrates a modularized single location uncoordinated sequential test;

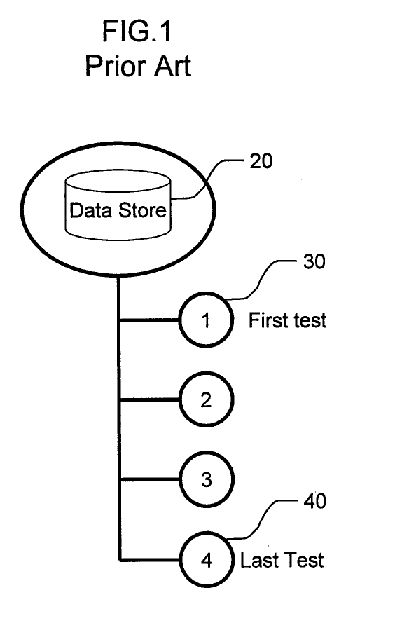

FIG. 2 illustrates a non-modularized coordinated multi-location test;

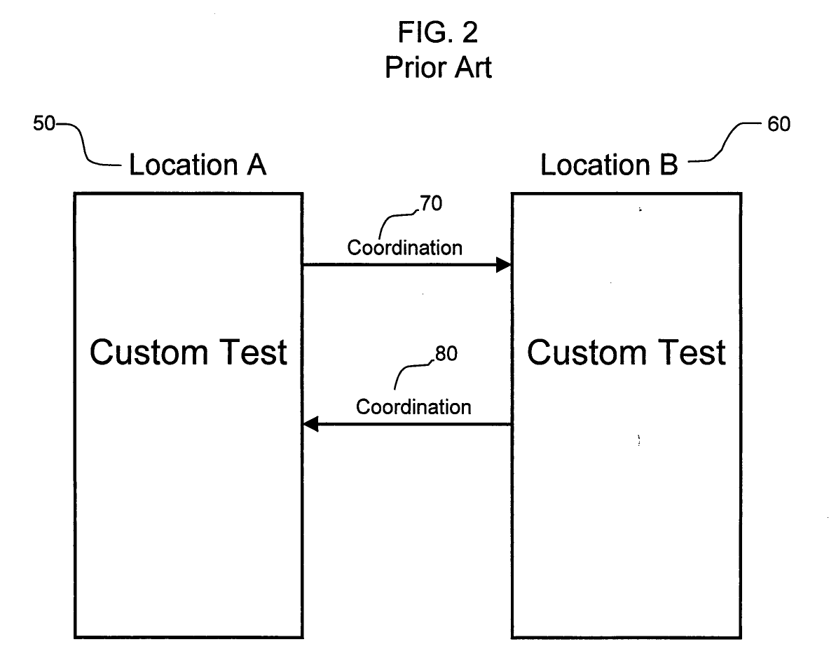

FIG. 3 illustrates an environment of an embodiment of the present invention;

FIG. 4 illustrates operation of an embodiment of the present invention;

FIG. 5 illustrates a graphical end user interface to construct a modularized coordinated multi-location test;

FIG. 6 illustrates operation of the test of FIG. 5; and

FIG. 7 further illustrates the operation of the test of FIG. 5.

### DETAILED DESCRIPTION

Reference will now be made in detail to embodiments of the present invention, examples of which are illustrated in the accompanying drawings, wherein like reference numerals refer to like elements throughout. The embodiments are described below to explain the present invention by referring to the figures.

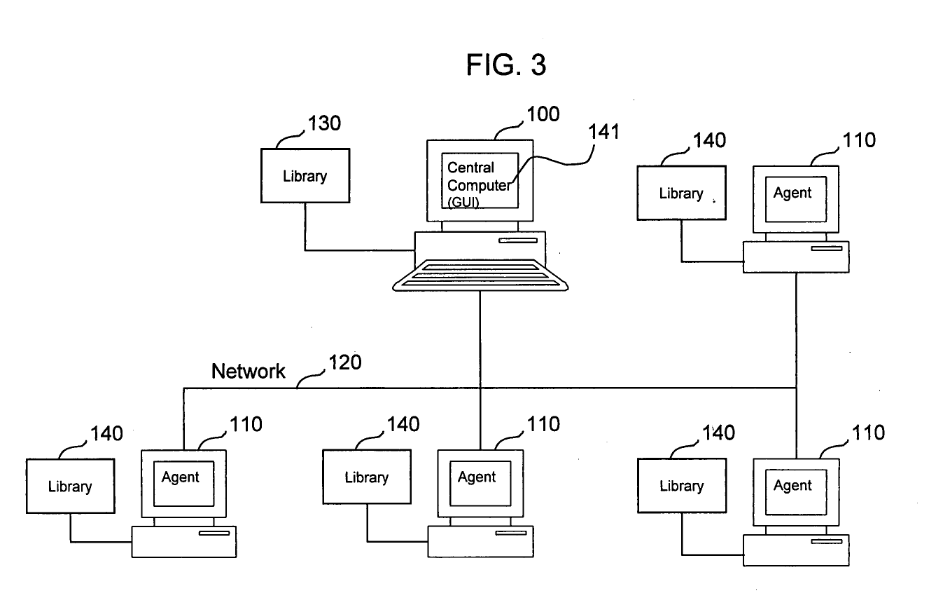

As is shown in FIG. 3, an environment of an embodiment of the present invention has, for example, a central computer 100 with a data store, or information holding environment (not shown), and a plurality of agents 110, each having a data store (not shown). The agents 110, communicate with each other and the central computer 100 via a network 120. The central computer 100 has a library 130 containing software modules. According to one aspect, each agent 110 also has a library 140 containing software modules. According to one aspect, the libraries 140 are copies of the library 130. According to another aspect, there is only one centrally located library 130, and the agents 110 access the library 130 via the network 120.

The libraries 130 and 140 contain different types of software modules, for example: test modules, which are software programs with well-defined input, well-defined output, and well-defined behavior, that perform predefined test operations; and coordination modules, to coordinate inter-operation of test modules in different flows (or subtests), which will be explained later.

Each software module has a list of input parameters, formatted, for example, as pairs of names and values. When a module needs to access an input parameter, it searches this list looking for the name of the input parameter and accesses its value. Each software module also has the capability to access a data store of an agent 110.

According to one aspect, test modules report a ‘test failed’ result at the outset, and change the result to success only if all the tests applied by the module succeed as expected. This allows, for example, a definitive result form each test module to be produced, even if the running of the test module has to be interrupted due to some catastrophic failure. Additionally, each test module reports success, failure or ‘incomplete result’ information after it completes its operation.

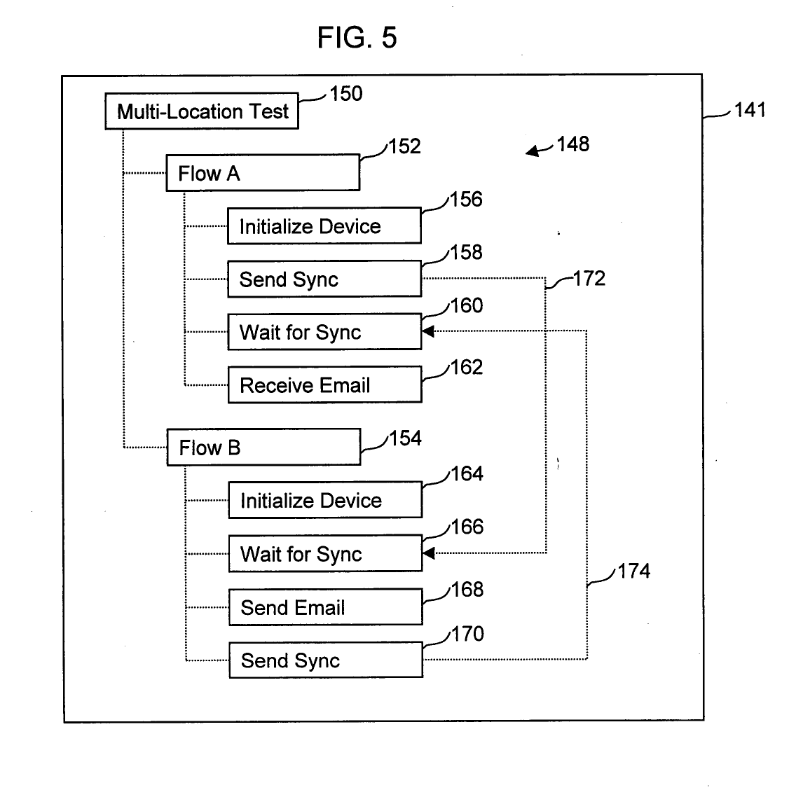

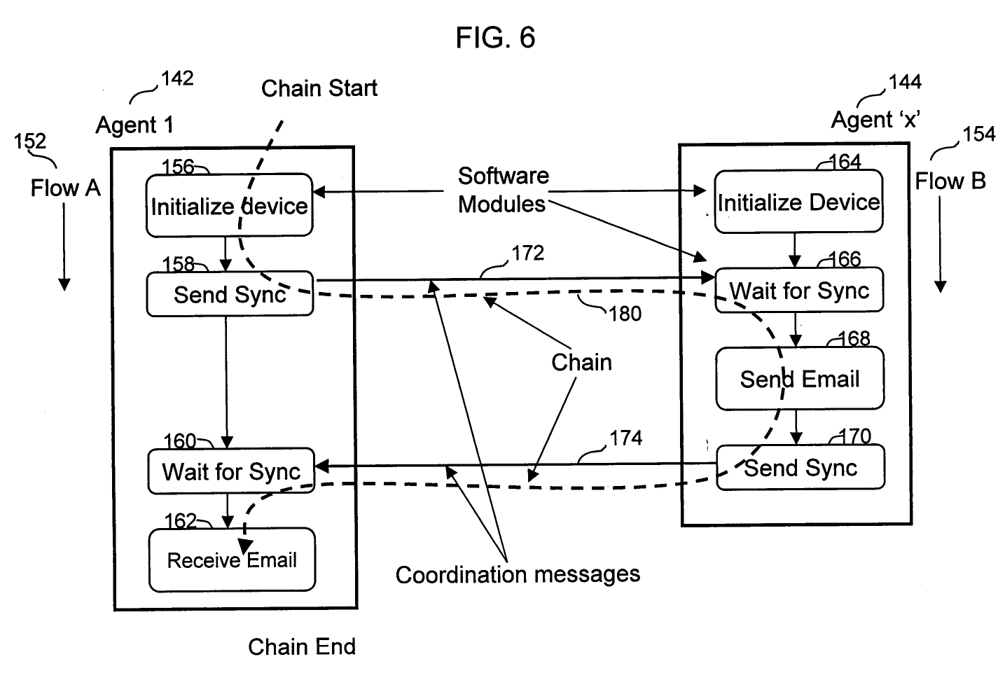

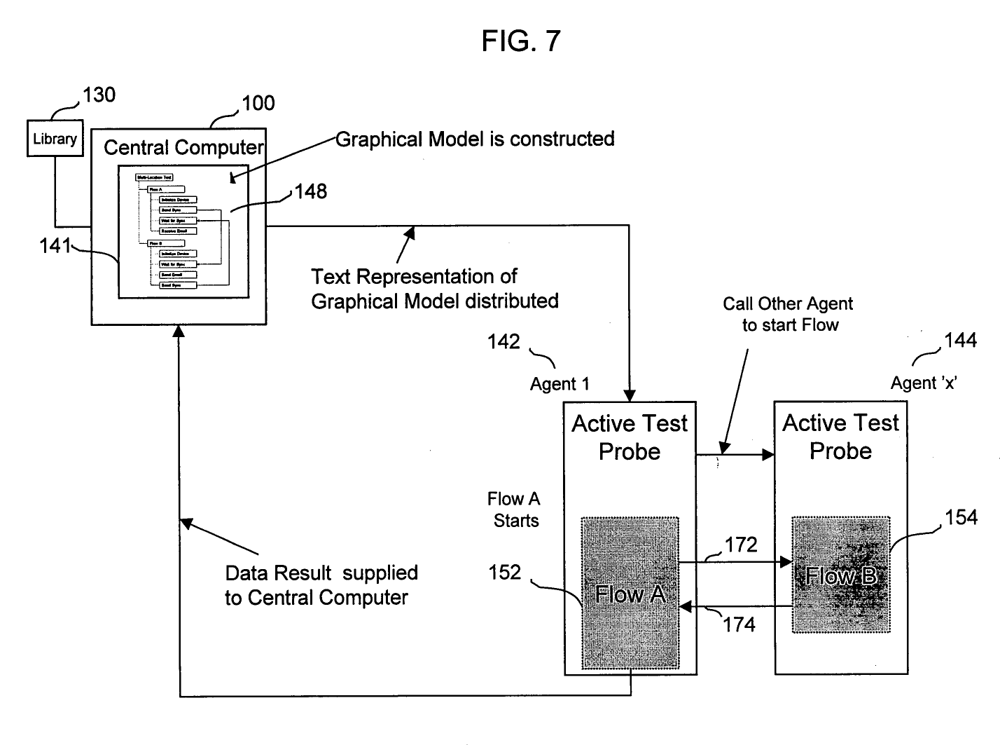

The central computer 100 also has a graphical end user interface (GUI) 141, in which an end user constructs a graphical model 148 (see FIG. 5) of a modularized coordinated multi-location test. The end user assembles the test and coordination modules from the library into a sequential run of software modules for each test location, called a flow (for example, 152 and 154—see FIGS. 6 and 7). Each flow is a special program that knows how to run a sub-program for each module, and sequentially runs the software modules contained therein.

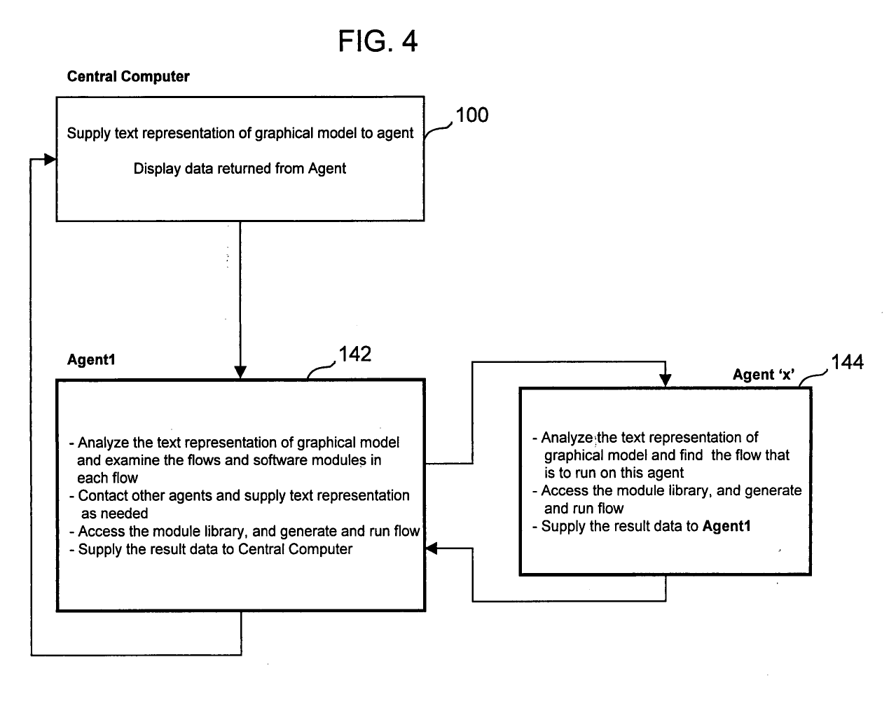

Coordination modules are, for example, employed in a pair, to create coordination points between the flows. A first member of the pair is employed in a first flow to send a coordination message to a second flow, and a second member of the pair is employed in the second flow, to receive the coordination message from the first member. Thus, by employing pairs of coordination modules, the end user also constructs a temporal sequence of operations among different flows called a chain. In other words, the chain is the meaningful sequence of test operations that is needed to test a multi-location system. Logically, the chain must start in one flow. The agent that runs this flow is the primary agent for the test, for example, Agent1 142 (see FIG. 4).

Each test module in a flow performs a predefined test operation on the system under test. All the test modules on all the flows in the multi-location test comprise all the test operations that the test system needs to do to complete the multi-location test.

Once the graphical model of the test is complete, the end user employs a conversion unit (e.g. a software program) to generate the flows from the graphical model. The conversion unit in this example has two parts: a converter to convert the graphical model into a text representation; and a parser to generate the flows from the text representation. According to one aspect, the converter uses a language such as XML to convert the graphical model into the text representation. Additionally, according to one aspect, the parser is a plurality of parsers located, respectively, at the plurality of agents 110.

The text representation is uploaded, for example, into a distributed test environment, which provides tools for starting the flows from a single location, and provides tools for sending. co-ordination messages between the flows.

Generally, the parser separates the flows for each test location, and creates a list of modules for each flow to run. These lists are used, for example, to start the flows for each test location, and each flow then runs the modules in the flow in a sequential manner.

So, as can be seen in FIG. 3, there is a plurality of libraries 140 of software modules maintained at a plurality of test locations (agents 110), respectively, of a network 120; and a graphical end user interface (GUI) 141 via which an end user constructs a graphical model 148 for a test of the network 120. The graphical model 148 includes flows respectively corresponding to test locations (agents 110), a respective flow for a corresponding test location (agent 110) being a flow of software modules from the library 140 maintained at the corresponding test location (agent 110).

FIG. 4 illustrates a general example of the process of running a multi-location test. Two of the plurality of agents 110 are shown in FIG. 4, Agent1 142 and Agent ‘x’ 144. Once the graphical model is converted into the text representation, the central computer 100 distributes the text representation to Agent1 142.

Agent1 142 analyzes the text representation and examines the flows, and the software modules in each flow. Based on the analysis, Agent1 142 contacts and supplies the text representation to other agents 110 as necessary, to start the flows that run on the respective agents 110. In the example illustrated in FIG. 4, Agent1 142 contacts Agent ‘x’ 144. Agent ‘x’ 144 then analyzes the text representation and finds the flow that is to run on Agent ‘x’ 144. Then the respective parsers of Agent1 142 and Agent ‘x’ 144 access their respective libraries 140 and generate and run their respective flows.

The agents 142 and 144 run their respective flows, and Agent ‘x’ 144 supplies the result data from the flow running on Agent ‘x’ 144 to Agent1 142. Once the flow running on Agent1 142 is complete, Agent1 142 supplies all the result data to the central computer 100, which displays the results. One of ordinary skill in the art will appreciate that Agent1 142 may coordinate with more than one Agent ‘x’, and that the simple example is merely illustrative. Additionally, one of ordinary skill in the art will appreciate that Agent1 142 may be the only agent for a given test, and that multiple test locations may exist at the single Agent1 142, and therefore, that multiple flows may run on the single Agent1 142 for a given test.

FIG. 5 illustrates an example of a graphical model 148 of a multi-location test 150 constructed using the GUI 141. The flows 152 and 154 and software modules 156-170 in the multi-location test 150 can be viewed, for example, as a multi-branch hierarchical ‘tree’. FIG. 5 shows this visualization. A ‘root’ of the tree shows the multi-location test 150. This root has two ‘branches’, each representing one of the flows 152 and 154. Each flow 152 and 154 shows the software modules 156-170 in the respective flow arranged in a sequential fashion.

The dotted arrows 172 and 174 show the co-ordination points between the flows 152 and 154. Generally, when a flow runs a wait for sync module, it waits for a message sent from another flow, and when a flow runs a send sync module, it sends the coordination message to a named flow. Once the coordination message is received at the destination flow, the flow completes the ‘wait for sync’ module and starts running the next module in the flow.

Thus, the multi-location test 150 in this example has two flows: flow A 152, and flow B 154. Flow A 152 has four software modules: initialize device 156; send sync 158, which coordinates with a wait for sync module 166 of flow B 154, via coordination message 172; wait for sync 160, which coordinates with a send sync module 170 of flow B 154 via coordination message 174; and receive email 162. Flow B also has four software modules: initialize device 164; wait for sync 166, which coordinates with the send sync module 158 of flow A 152, via the coordination message 172; send email 168; and send sync 170, which coordinates with the wait for sync module 160 of flow A 152, via the coordination message 174.

FIG. 6 illustrates an example of an implementation of the multi-location test 150. In this example, a chain 180 starts in flow A 152, at the initialize device module 156, and then proceeds from the send sync module 158 to the wait for sync module 166 of flow B 154. Next in the chain 180, is the send email module 168, followed by the send sync and wait for sync modules 170 and 160. Finally, the chain ends with the receive email module 162.

Multi-location tests may generate run time information (test generated data), such as a time of completion for a certain operation, and store such information in the associated agent's data store. But, the test generated data may be information that needs to be supplied to another flow to produce meaningful measurements in the test. For example, in FIG. 6, the send email module 168 in Flow B 154 may report a time at which a send email operation was completed. This information must be available at Flow A when the receive email module 162 runs, so that the time between origination and receipt of the email may be calculated. Additionally, the send email module 168 may also have some unique identifying information about the sent email, which can be used by the receive email module 162 to select the correct email, from among many received emails.

Generally, while coordination messages convey synchronization signals between flows, according to one aspect, coordination messages also convey test generated data. In a multi-location test, the next test module in the chain is the one most likely to need test-generated data from a previous module. If, for example, the next test module in the chain is in the same flow, this data is available in the data store of the agent that runs the flow. If, however, the next test module in the chain is in another flow, then there must be a co-ordination module pair that sends the co-ordination message (including the test generated data) in the direction of the chain, i.e., from the flow containing the previous test module to the flow containing the next test module.

For example, as shown in FIG. 6, the information that needs to be conveyed to flow A 152 is specified in the send sync module 170. The send sync module 170 extracts the test generated data from the data store of agent ‘x’ 144, and sends the test generated data in the co-ordination message 174. The wait for sync module 160 extracts the test generated data from the co-ordination message 174, and stores test generated data in the data store of agent1 142. When the next test module in the chain (the receive email module 162) runs, it will have this test generated data ready for use.

According to one aspect, the test generated data is formatted in a predefined format. For example, a standardized data exchange format such as XML can be used.

FIG. 7 illustrates an example of an entire process of construction and implementation of the multi-location test 150. The end user constructs the graphical model 148 on the central computer 100 using the GUI 141 and the library 130 containing the software modules, and directs the central computer 100 to convert the graphical model 148 and distribute the text representation. For the multi-location test of this example, there are two test probes needed, located respectively at agent1 142 and agent ‘x’ 144. Agent 1 142 receives and analyzes the text representation, and distributes the text representation to agent ‘x’ 144. Agent1 142 and agent ‘x’ 144 access their respective libraries 140, and respectively run flow A 152 and flow B 154. Coordination messages 172 and 174 coordinate synchronization and transfer of test generated data between flows A and B 152 and 154. Then, when the flows are complete, agent 1 142 supplies the data result to the central computer 100.

In FIG. 7, the end user runs the GUI 141, constructs the graphical model, and runs the test from a location remote from any of the test locations (agent1 142 and agent ‘x’ 144). One of ordinary skill in the art will appreciate, for example, that the graphical model may be constructed, and the test may be run from one of the agents (agent1 142 and agent ‘x’ 144). Further, one of ordinary skill in the art will appreciate that the test may be run from a location different from where the graphical model was constructed. Further still, it will be appreciated, that one of the plurality of agents 110 may be any type of device connected to a network, such as a computer, a printer, or a router. Yet further still, it will be appreciated that the network 120 may be a wireless network, and that an agent 110 may be a wireless device, such as a cell phone.

So, as can be seen in FIGS. 6 and 7, there is a library 130 of software modules, including test modules (156, 162, 164, and 168) and coordination modules (158, 166, 170, and 160); and a graphical end user interface 141 to design via which an end user constructs a graphical model 148 for a multi-location test of a network 120 (see FIG. 3). The graphical model 148 includes flows (152 and 154) respectively corresponding to test locations (142 and 144), a respective flow for a corresponding test location being a flow of at least one software module, wherein test modules (156, 162, 164, and 168) perform predefined test operations and coordination modules (158, 166, 170, and 160) coordinate inter-operation of test modules (156, 162, 164, and 168) in different flows (152 and 154).

Examples of flows are illustrated herein. But the present invention is not limited to these specific examples. Instead, many variations are possible.

Similarly, examples of graphical models, software modules, test locations, agents, test probes, conversion units, and libraries are illustrated herein. But the present invention is not limited to these specific examples. Instead, many variations are possible.

Although a few embodiments of the present invention have been shown and described, it will be appreciated by those skilled in the art that changes may be made in these embodiments without departing from the principles and spirit of the invention, the scope of which is defined in the appended claims and their equivalents.

1. An apparatus comprising:
a plurality of libraries of software modules maintained at a plurality of test locations, respectively, of a network; and
a graphical end user interface (GUI) via which an end user constructs a graphical model for a test of the network, the graphical model including flows respectively corresponding to test locations, a respective flow for a corresponding test location being a flow of software modules from the library maintained at the corresponding test location.

2. An apparatus as in claim 1, wherein the GUI is run at a location remote from at least one test location, so that the end user constructs the graphical model and runs the test from the remote location.

3. An apparatus comprising:
a library of software modules; and
a graphical end user interface (GUI) via which an end user constructs a graphical model for a multi-location test of a network, the graphical model including flows respectively corresponding to test locations, a respective flow for a corresponding test location being a flow of software modules from the library.

4. The apparatus according to claim 3, wherein:
the GUI is run at a location remote from at least one test location, so that the end user constructs the graphical model and runs the test from the remote location.

5. The apparatus according to claim 3, wherein:
each flow sequentially runs the software modules contained therein.

6. The apparatus according to claim 3, wherein the software modules comprise:
test modules that perform predefined test operations; and
coordination modules to coordinate inter-operation of test modules in different flows.

7. The apparatus according to claim 6, wherein coordination modules are employed in a pair, comprising:
a first member of the pair employed in a first flow to send a coordination message to a second flow; and
a second member of the pair employed in the second flow to receive the coordination message from the first member.

8. The apparatus according to claim 7, wherein:
the coordination message also contains test generated data.

9. The apparatus according to claim 8, wherein:
the test generated data is formatted in a predefined format.

10. The apparatus according to claim 8, wherein:
each test location has an associated information holding environment, in which the test generated data is stored.

11. The apparatus according to claim 3, further comprising:
a conversion unit to generate the flows from the graphical model.

12. The apparatus according to claim 11, wherein the conversion unit comprises:
a converter to convert the graphical model into text; and
a parser to generate the flows from the text.

13. The apparatus according to claim 12, wherein:
the parser interacts with the library to generate the flows

14. The apparatus according to claim 12, wherein:
a language used by the converter to convert the graphical model into text is XML.

15. The apparatus according to claim 3, wherein:
the library is centrally located.

16. The apparatus according to claim 3, wherein:
a copy of the library is distributed to each test location.

17. An apparatus comprising:
a library of software modules, including test modules and coordination modules; and
a graphical end user interface (GUI) via which an end user constructs a graphical model for a multi-location test of a network, the graphical model including flows respectively corresponding to test locations, a respective flow for a corresponding test location being a flow of at least one software module,
wherein test modules perform predefined test operations and coordination modules coordinate inter-operation of test modules in different flows.

18. An apparatus comprising:
a library of software modules;
a graphical end user interface via which an end user designs a graphical model of multi-location test software, in which a subtest of at least one software module is constructed for each test location.

19. An apparatus comprising:
a library of software modules, including test modules, and coordination modules;
a graphical end user interface to design a graphical model of software to test multiple test locations of a network, in which
a flow of at least one software module is constructed for each test location, and coordination modules coordinate inter-operation of test modules in different flows and communicate test generated data with the different flows;
a conversion unit to generate the flows from the graphical model;
at least one agent to run the flows;
at least one probe deployed at each test location to collect data from at least one attribute of the network and communicate the data with the at least one agent; and
a central controller to control running of the flows and collect the data from the at least one agent.

20. A computer readable medium, comprising:
a first set of instructions housing a library of software modules, including test modules and coordination modules;
a second set of instructions creating a graphical user interface (GUI) via which via which an end user constructs a graphical model for a multi-location test of a network, the graphical model including flows respectively corresponding to test locations, a respective flow for a corresponding test location being a flow of at least one software module;
a third set of instructions to convert the graphical model to a text representation of the multi-location test;
a fourth set of instructions controlling an agent to receive and analyze the text representation, access the library, and run the flows for each test location; and
a fifth set of instructions coordinating synchronization and exchange of test generated data between flows.
